(19) United States
(12) Patent Application Publication
(10) Pub. No.: US 2017/0244355 A1
(43) Pub. Date: Aug. 24, 2017

(54) ADJUSTABLE ANGLE SOLAR POWER GENERATION SYSTEM

(71) Applicant: JENC CORPORATION, Kyoto (JP)

(72) Inventor: Tomio YANAGI, Kyoto (JP)

(21) Appl. No.: 15/271,974

(22) Filed: Sep. 21, 2016

(30) Foreign Application Priority Data
Feb. 22, 2016 (JP) 2016-030567

(51) Int. Cl. H02S 20/32; H02S 30/10

(52) U.S. Cl. CPC H02S 20/32; H02S 30/10

(57) ABSTRACT

An adjustable angle solar power generation system that can decrease a tilt control angle of a solar panel without narrowing a range where the sun is tracked. The system includes a supporting portion that supports a solar panel to be capable of being tilted within a range in which the solar panel is tilted at an arbitrary angle in only one direction from a horizontal state, and a revolving portion that supports the supporting portion from below so as to be rotatable around a vertical axis. The revolving portion supports the supporting portion so as to be rotatable in such a manner that a tilt range of the solar panel is reversed with the vertical axis being defined as a symmetric axis, enabling the solar panel to tilt in both directions within the same range before and after the rotation of the revolving portion.

### TECHNICAL FIELD

The disclosure relates to solar power generation systems, and more particularly, to solar power generation systems in which the angle of a solar panel is adjustable within a predetermined angular range.

### BACKGROUND

Many conventional solar power generation systems are of a static type, in which a solar panel is fixed in spatial orientation on a roof, base, or other support structure, such that the angle of the light-receiving surface does not move relative to the support structure. Therefore, the time at which rays of sunlight are perpendicular to the light-receiving surface to provide the highest power generation efficiency is limited.

In order to solve this problem, solar power generation systems have been developed that vary the angle of a solar panel to track the movement of the sun. Such sun-tracking solar power generation systems can adjust the angle the light-receiving surface of the solar panel makes with the panel support, which enables the light-receiving surface to be positioned perpendicular or normal to the rays of the sun, and prolongs the amount of time this orientation, or an angle close to this orientation, whereby the power generated by the solar panel for a given day is increased relative to that of the fixed type of solar panel.

Relevant technologies are disclosed in the following documents: Japanese Translation of PCT Publication No. 2014-522624; Japanese Open Gazette No. 2011-253997; Japanese Open Gazette No 2011-35337; Japanese Open Gazette No 2003-324210; Japanese Open Gazette No 2001-91818; Japanese Patent No. 5057412; Japanese Patent No. 4873279; and Japanese Patent No. 3539729.

In a tracking solar power generation system in which the center of a solar panel is supported on a base through a rotatable axis to vary the tilt angle of the solar panel during the day according to the angle of the sun with the horizon, in the case where the solar panel is tilted to the east and to the west, each at an angle of a maximum of 45°, for example, the tilt (swing) of the solar panel has been conventionally controlled within the range of 90° in total; that is, from the state in which the solar panel is tilted at an angle of 45° to the east at sunrise to the state in which the solar panel is tilted at an angle of 45° to the west at sunset. However, in consideration of the weight of the solar panel or the load to the rotatable axis with wind, it is preferable that the tilt control angle (rotation angle) of the solar panel is set as small as possible.

In addition, comparing the operation for bringing the solar panel tilted at an angle of 45° into a horizontal state and the operation for bringing the solar panel in the horizontal state into the state of being tilted at an angle of 45° using a motor as a power source, the former operation for raising up the solar panel tilted to one side to the horizontal state requires larger torque (power consumption) than the latter operation for tilting the solar panel in the horizontal state to the opposite side. Conventionally, the operation for raising up the solar panel is performed at least twice during 24 hours, that is, between sunrise and noon and after sunset, which is a period in which the solar panel tilted at an angle of 45° to the west is raised to the horizontal state during the operation for tilting the solar panel at an angle of 45° to the east for preparation of the power generation of the next day. Therefore, there is a room for improvement from the viewpoint of the power consumption of the motor.

As for the above-mentioned point, if the maximum tilt angle of the solar panel to one side is decreased from 45° to 30°, the tilt control angle of the solar panel can be decreased. However, if so, the range where the sun is tracked (the range where the solar panel faces the sunlight) is narrowed, which decreases the power generation amount. This deteriorates the technical meaning in designing the sun tracking type.

### SUMMARY

The disclosed adjustable angle power generation system addresses the foregoing problems, and in an embodiment provides an adjustable angle solar power generation system that can decrease a tilt control angle of a solar panel without narrowing the range in which the sun is tracked.

The disclosed adjustable power generation system uses a configuration including a supporting portion that supports a solar panel which can be pivoted within a range in which the solar panel is tilted at an arbitrary angle in only one direction from a horizontal state; and a revolving portion that supports the supporting portion from below so as to be rotatable around a vertical axis.

According to the configuration described above, the supporting portion pivots the solar panel only in one direction on one side, whereby the tilt control angle can be decreased. On the other hand, if the supporting portion is rotated 180° in the horizontal direction by the revolving portion, the solar panel is also rotated 180°, and the tilt range is reversed. Thus, the solar panel can be tilted on both sides within the same angular range before and after the reverse operation. Accordingly, if the arbitrary set tilt angle range is set to a maximum of 45°, for example, the sun can be tracked within the angular range of 90° in total, which is the same as the sun tracking range of a conventional system.

Control of the supporting portion or the revolving portion, such as the setting of the tilt angle of the solar panel by the supporting portion or the rotation angle of the revolving portion, is arbitrary. However, in order to track the movement of the sun in the day, the revolving portion is preferably configured to support the supporting portion so as to be rotatable in such a manner that the swing range of the solar panel can be reversed with the vertical axis being defined as a symmetric axis, enabling the solar panel to swing in both directions within the same range before and after the rotation of the revolving portion. More specifically, the revolving portion is preferably rotatable within the range of 180° in normal and reverse directions around the vertical axis.

In addition, the drive control of the supporting portion and the revolving portion is arbitrary. However, if the revolving portion is rotationally driven when the solar panel is in the horizontal state, the supporting portion can be rotated in the state where the solar panel presents the least wind resistance. On the other hand, if the supporting portion and the revolving portion are simultaneously driven, the solar panel can more effectively face the sunlight in the season from autumn to spring when the culmination altitude of the sun is lower than in the season from spring to autumn.

In an exemplary embodiment, the supporting portion may include a rotatable axle provided at a center of a back of the solar panel; a lever-shaped actuator that integrally projects from the rotatable axle obliquely downward and performs a reciprocating movement to the left and right to allow the solar panel to swing; and a power source for the supporting portion, the power source operating the actuator so as to be capable of performing the reciprocating movement, and the actuator projects from the rotatable axis so as to form an acute angle with a panel surface which is swung downward when the solar panel is swung. Specifically, when the actuator is provided vertical to the panel surface, the actuator performs the reciprocating movement at one side within the range from the center of the panel while the solar panel is tilted within the angular range. When being angled, the actuator can perform the reciprocating movement to the left and right from the center of the panel within the same angular range, and the structure for transmitting power from the power source for the supporting portion to the actuator can be made symmetrical.

On the other hand, as the specific configuration example, the revolving portion preferably includes: a rotary drum that supports the supporting portion on a cylinder so as to be rotatable in a horizontal direction; a roller that has an outer peripheral surface in contact with a cylinder wall of the rotary drum and is freely rotatable in the horizontal direction; and a power source for the revolving portion, the power source applying power to the roller to rotationally drive the rotary drum.

In addition, if the rotary drum is formed into a hollow cylindrical shape, and the roller is mounted inside the rotary drum, the roller can be protected from rain and wind, whereby deterioration of the roller can be reduced.

Further, if a reinforcement drum is concentrically mounted at the outside of the rotary drum through a bearing, collapse of the rotary drum can be prevented by the reinforcement drum, whereby resistance to wind of the entire system can be enhanced.

The present system may allow a solar panel to pivot in one direction on one side from a horizontal state. Therefore, as compared with a conventional system that allows a solar panel to pivot within the whole range on both sides of its support, a tilt control angle of the solar panel can be reduced by half, whereby the rotation control of the solar panel can be simplified and power saving can be achieved. Further, since the present invention includes the revolving portion that can reverse the solar panel, the present invention enables tracking of the sun in the same range as the conventional system with the reduced tilt control angle.

### BRIEF DESCRIPTION OF THE DRAWINGS

FIG. 1 shows a perspective view of an exemplary embodiment of the disclosed adjustable angle solar power generation system;

FIG. 2 is a side elevational view in section of the adjustable angle solar power generation system of FIG. 1;

FIG. 3 is a side elevational view of a supporting portion of the adjustable angle solar power generation system of FIG. 1;

FIG. 4 is a perspective view of the supporting portion of the adjustable angle solar power generation system of FIG. 1;

FIG. 5 is a perspective view, partially cut away, of the revolving portion of the adjustable angle solar power generation system of FIG. 1;

FIG. 6 is a top plan view of the revolving portion of the adjustable angle solar power generation system of FIG. 1;

FIG. 7 is a partial side elevational view, in section, of the revolving portion of the adjustable angle solar power generation system of FIG. 1;

FIG. 8 is a top plan view, in section, of the reinforcement structure of the revolving portion of the adjustable angle solar power generation system of FIG. 1; and

FIG. 9 is a side elevational view, in section, showing a modification of the revolving portion of the adjustable angle solar power generation system of FIG. 1.

### DETAILED DESCRIPTION

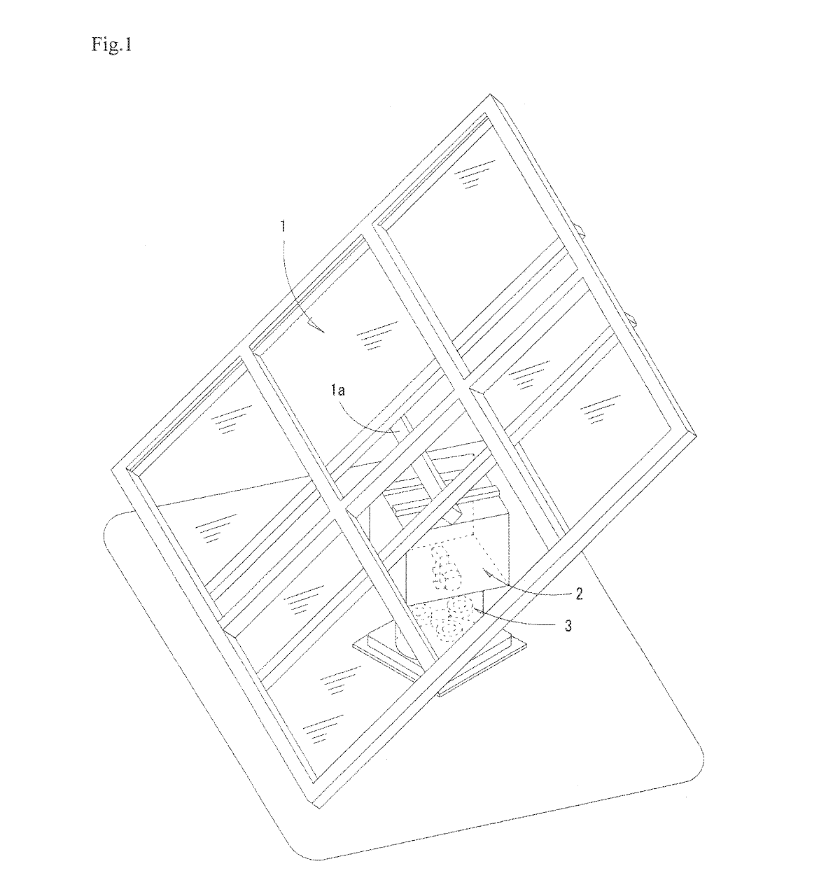

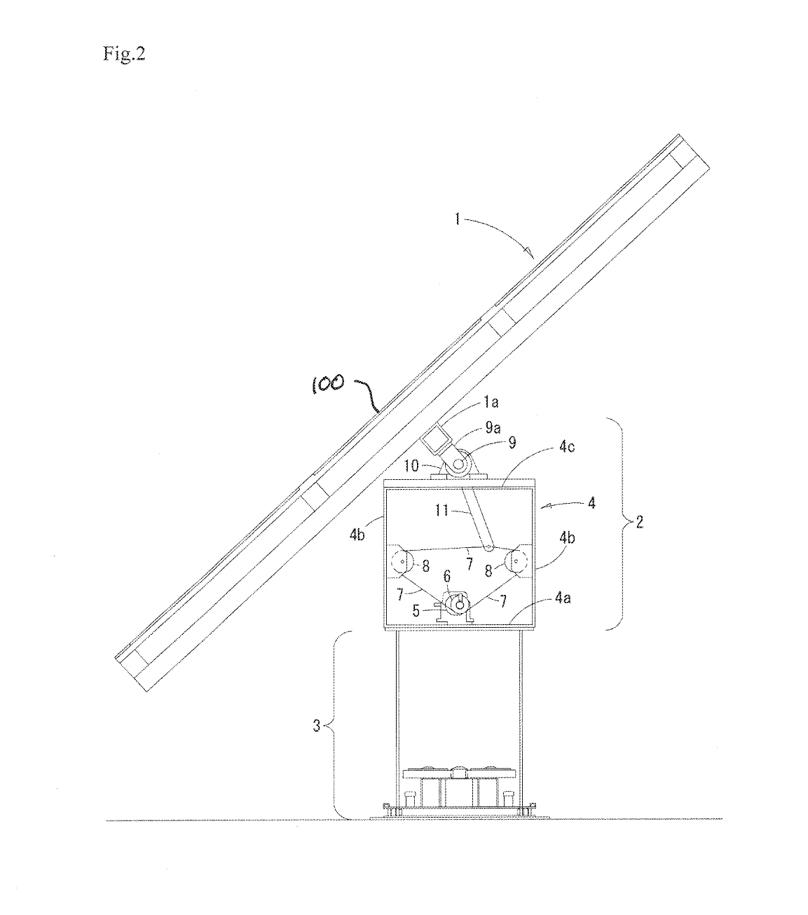

FIG. 1 is a perspective view illustrating an embodiment of the disclosed solar power generation system, wherein an internal structure is seen through, and FIG. 2 is a side elevational view thereof in which a box-like structure at an upper part is a supporting portion for a solar panel 1, and a cylindrical structure at a lower part is a revolving portion 3.

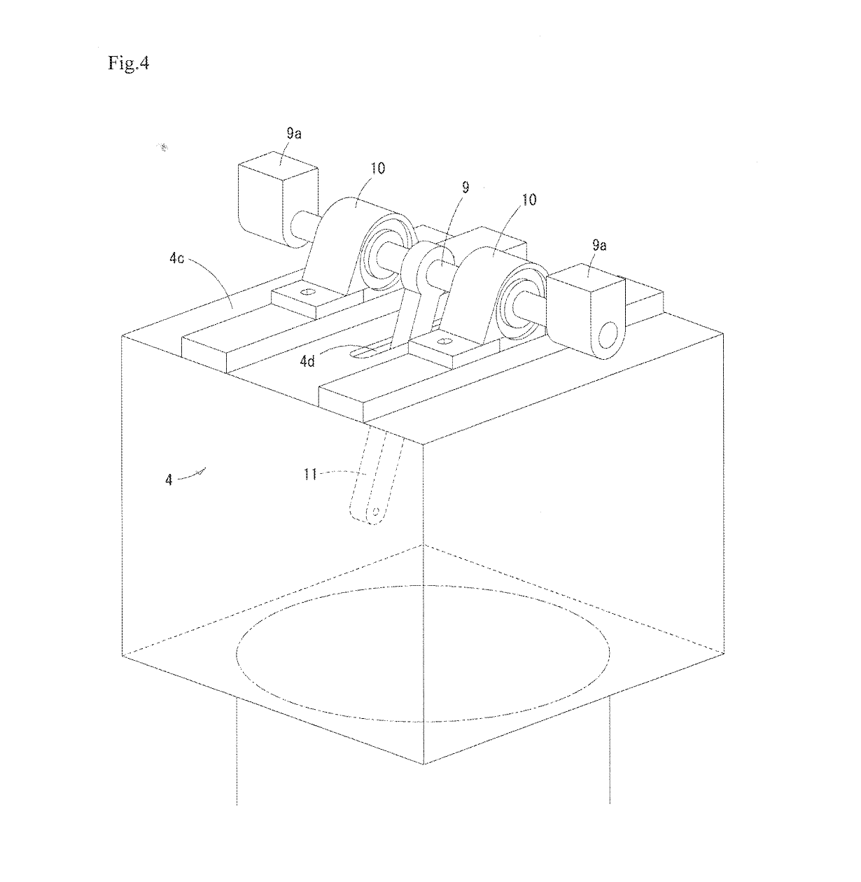

A supporting portion 2 supports the solar panel 1 to be tilted or pivoted in one direction in the horizontal direction (same as the horizontal direction in the drawing) corresponding to an east-west orientation, or generally east-west orientation, of the solar panel in a predetermined angular range. The specific structure of the supporting portion 2 is such that, as is apparent from FIGS. 2 to 4, a reel 6 that is driven by an electric motor 5 serving as a power source is provided inside a housing 4, which is formed from an appropriate material such as a metal plate, to be fixed on a housing bottom plate 4a, and a pair of pulleys 8 around which a wire 7 fed out from the reel 6 is looped are provided on both of left and right side plates 4b and 4b of the housing 4 on the same level. The supporting portion 2 also includes, on a housing top plate 4c, a horizontally rotatable axle 9 extending in the longitudinal direction (e.g., a north-south orientation) and a bearing 10 into which the rotatable axle 9 is inserted to be freely rotatable in both the clockwise and counterclockwise directions. In the present embodiment, a pair of bearings 10 is provided with a predetermined space therebetween in the longitudinal direction as illustrated in FIG. 4.

Mounting portions 9a are provided at both ends of the rotatable axle 9. The mounting portions 9a are bonded to a crossbar 1a (see FIG. 1) provided at the center on the back of the solar panel 1 along the longitudinal direction, whereby the solar panel 1 and the rotatable axis 9 are integral and fixed relative to each other.

An actuator 11 projects downward from the rotatable axis 9. The actuator 11 has a lever-like shape, which may take the form of an elongate lever arm, and serves as a pendulum such that its lower end can make a horizontal reciprocating movement with the rotatable axis 9 as a supporting point since its upper end is integrally fixed to the center of the rotatable axis 9, and this reciprocating movement enables the rotatable axle 9 to rotate in the clockwise and counterclockwise directions.

In the present embodiment, the actuator 11 projects into the housing 4 through a slit 4d formed between the bearings 10 on the housing top plate 4c, and both ends of the wire 7 fed out from the reel 6 through the pulleys 8 are connected to one point of the lower end. Therefore, when the electric motor 5 is driven to rotationally drive the reel 6, one end of the wire 7 is wound around the reel 6, so that the lower end of the actuator 11 is pulled toward this direction, resulting in rotating the rotatable axle 9. When the electric motor 5 is driven to rotate in the reverse direction, the opposite end of the wire 7 is then wound around the reel 6, so that the lower end of the actuator 11 is pulled toward the opposite direction, resulting in rotating the rotatable axle 9 in the reverse direction.

With the above-described operation, the solar panel 1 pivots or tilts with the rotation of the axle 9 about a central (i.e., concentric with the axle 9) longitudinal rotational axis of the axle as a supporting point to move in a predetermined angular range between a horizontal orientation and an elevated or tilted orientation at an arbitrary or pre-selected tilt angle to the horizontal in one direction. In the disclosed system, the solar panel 1 is configured not to tilt or elevate to the left and to the right (as shown in FIG. 2, for example) in the same angular range from a horizontal orientation, but rather to tilt only to one of the left or to the right from the horizontal state. Thus, the tilt or elevation control angle of the solar panel 1 can be decreased, whereby pivoting the solar panel 1, which has a large area and is a heavy load, can be facilitated and reliably implemented.

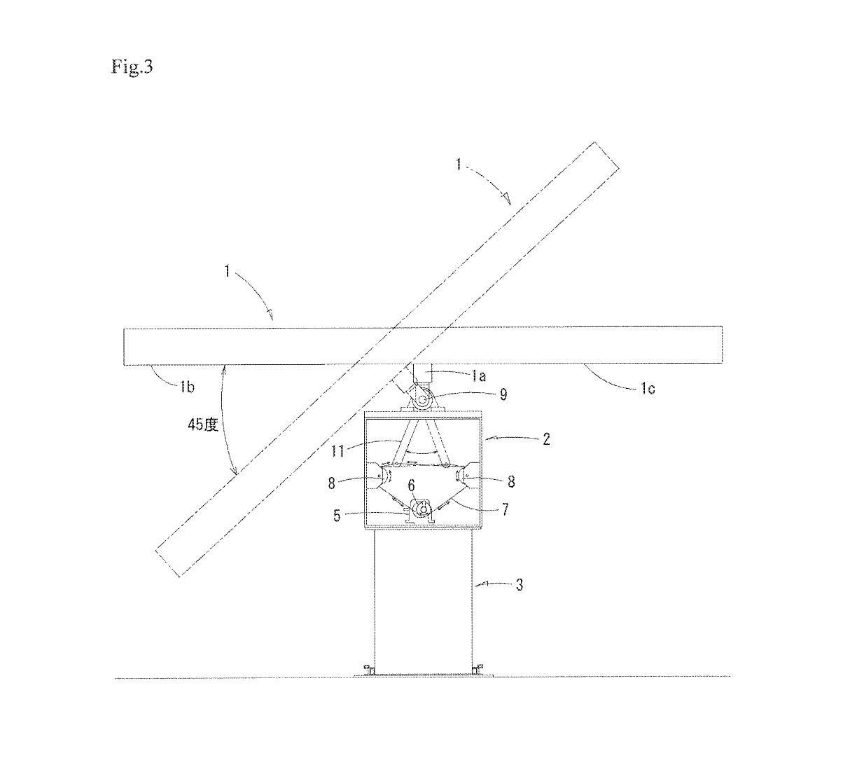

In an embodiment, the actuator 11 is not perpendicular to the flat panel surface 100 of the solar panel 1, but is oriented at an angle to the panel surface as illustrated in FIG. 3. Specifically, the upper end of the actuator 11 is fixed to the rotatable axle 9 at an angle so as to form an acute angle with the panel surface 100 of the solar panel 1 at the side swinging downward from a horizontal line from the horizontal state of the solar panel 1, that is, a left panel surface 1b out of left and right panel surfaces 1b and 1c (which may be parallel to surface 100) which are sectioned with the crossbar 1a as a centerline of the panel 1. Accordingly, while the actuator 11 reciprocates to the left and right across a vertical line vertically passing through the rotatable axle 9, the solar panel 1 is tilted only to the left from the horizontal.

In an embodiment, the mounting angle of the actuator 11 relative to the panel surfaces 1b and 1c may be arbitrary. However, it is preferable that the angle (tilt angle) made by the actuator 11 with the vertical line is the same at the left and right sides in each of the horizontal state and the maximum tilt state of the solar panel 1. With this configuration, when the solar panel 1 is pivoted or tilted between the horizontal state and the maximum tilt state, the electric motor 5 serving as the power source and the reel 6 can be driven to rotate at the same rotation angle in the clockwise and counterclockwise directions (as shown in, e.g., FIG. 2), which facilitates the motor control. In addition, since the pivot angle of the actuator 11 becomes symmetric, the center of gravity of the housing 4 (supporting portion 2) can be stabilized.

As described above, the supporting portion 2 of the present invention has only the function of swinging or pivoting the solar panel 1 either to the left or right from a horizontal position. However, in the disclosed system, the supporting portion 2 is supported by the revolving portion 3 to be rotatable in the horizontal or azimuthal direction. Therefore, the disclosed system implements the pivot of the solar panel 1 both to the left and right in the same angular range as a whole.

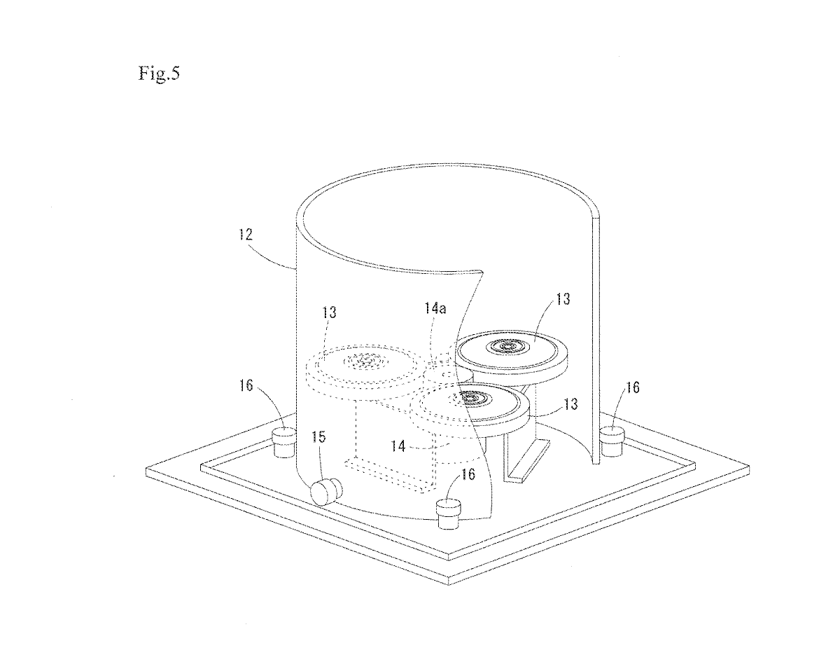

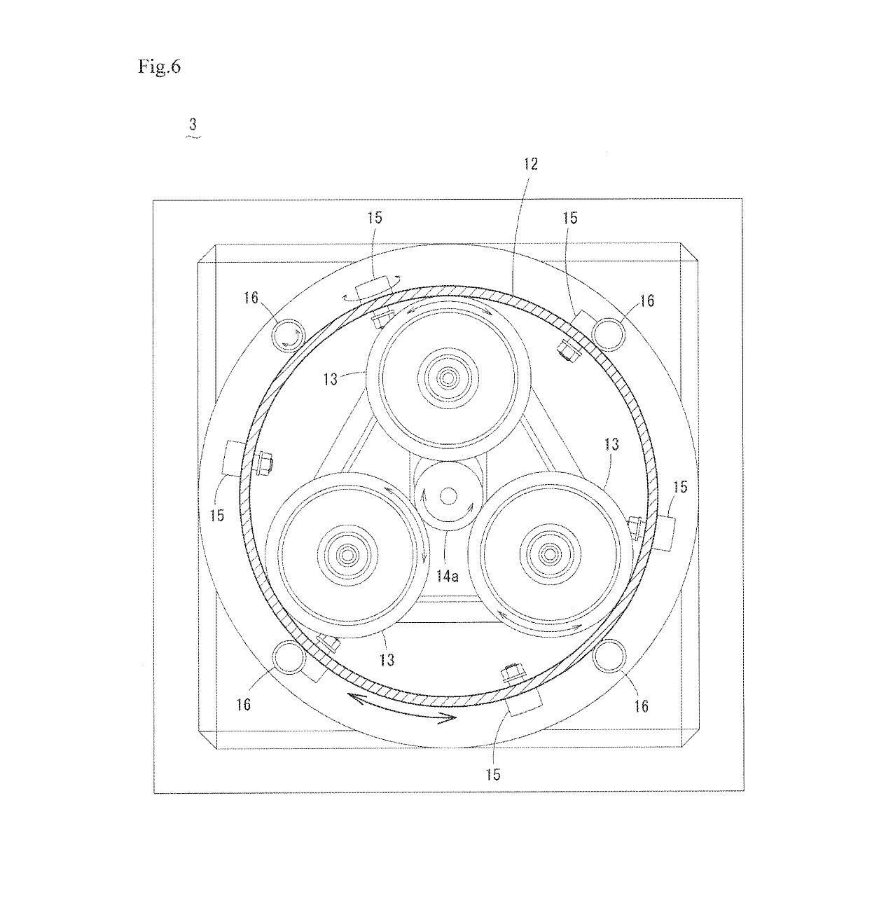

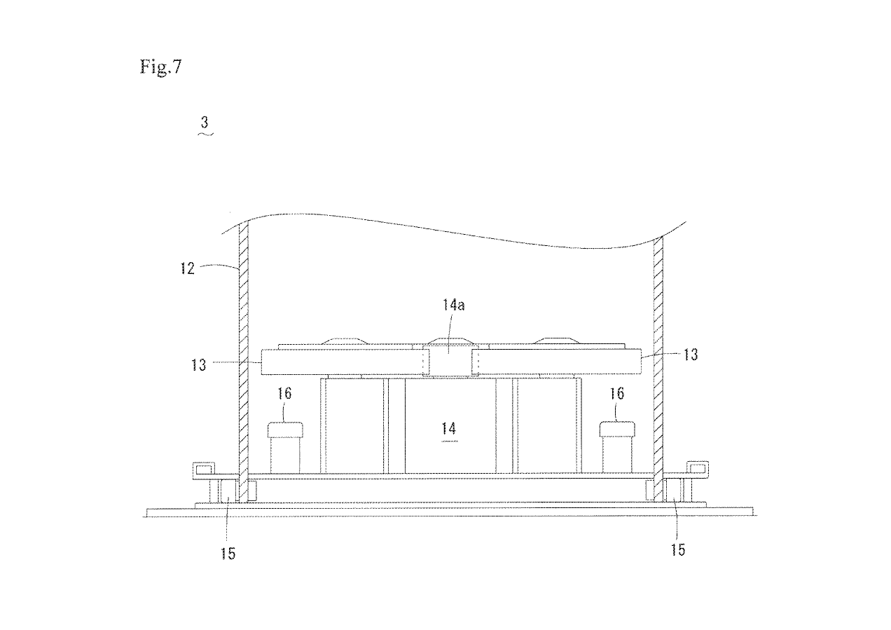

As illustrated in detail in FIGS. 5 to 7, the revolving portion 3 includes a hollow cylindrical rotary drum 12 provided with the supporting portion 2 on a cylinder. The revolving portion 3 also includes, as its power source, three horizontally rotating rollers 13 disposed in the rotary drum 12 and an electric motor 14 provided at the center of these three rollers 13.

The rotary drum 12 is a hollow cylinder formed from an appropriate material such as a metal pipe, and has a central vertical axis concentric with the drum. The rotary drum 12 has on its lower part a plurality of rollers (wheels) 15 rotating in the circumferential or azimuthal direction, thereby implementing 360° horizontal rotation around the cylinder axis (coinciding with the vertical axis). It is to be noted that cam follower rollers 16 are provided around the rotary drum 12 to be in contact with the outer peripheral surface of the rotary drum 12, and they may restrict or limit the azimuthal rotation position of the rotary drum 12. Notably, the same rollers may be used for the rollers 15 and the cam follower rollers 16.

In the present embodiment, a power source is provided in the rotary drum 12. The electric motor 14 is vertically disposed coaxially with the cylinder axis (rotation axis) of the rotary drum 12 at the center of the rotary drum 12, and three rollers 13 are disposed around the electric motor 14 to form a triangle. A columnar wheel 14a with a diameter inscribed in three rollers 13 is mounted on a pinion shaft of the electric motor 14, and when the electric motor 14 is driven, the three rollers 13 are simultaneously rotated in the same direction through the wheel 14a. Naturally, if the electric motor 14 is driven to be rotated in the clockwise direction, the three rollers 13 are simultaneously rotated in the counterclockwise direction. Notably, the electric motor 14 may be a geared motor. However, other types of electric motor may be substituted without departing from the scope of the disclosure.

Since the outer peripheral surfaces of these three rollers 13 are in contact with the inner peripheral surface of the rotary drum 12, the rotary drum 12 is rotated in the horizontal or azimuthal direction through the three rollers 13 due to the drive of the electric motor 14.

Notably, the outer peripheral surface of each of the rollers 13 is in contact with the rotary drum 12 and preferably is formed from a rubber layer or sleeve. This is because the rotary drum 12 can be reliably and accurately rotated with the friction force. For example, a tire for vehicles may be provided. If a tire for vehicles is provided, a run-flat tire that can keep the contact pressure (friction force) with the rotary drum 12 for a long time after being punctured may be preferable.

According to the foregoing revolving portion 3, when the electric motor 14 is driven, the three rollers 13 that are in contact with the wheel 14a mounted to the pinion shaft are simultaneously rotated in the direction opposite to the rotating direction of the electric motor 14, and thus, the rotary drum 12 is rotated in the opposite direction as the rotating direction of the rollers 13 and the same direction as the wheel 14a. The supporting portion 2 placed on the rotary drum 12 is also rotated with the solar panel 1 in the horizontal direction.

If the rotary drum 12 is rotated 180° with the operation of the revolving portion 3, the solar panel 1 will be reversed in orientation from left to right. If the rotary drum 12 is again rotated 180° in the same direction or in the opposite direction, the solar panel 1 is returned to the original left-right orientation shown in FIG. 2.

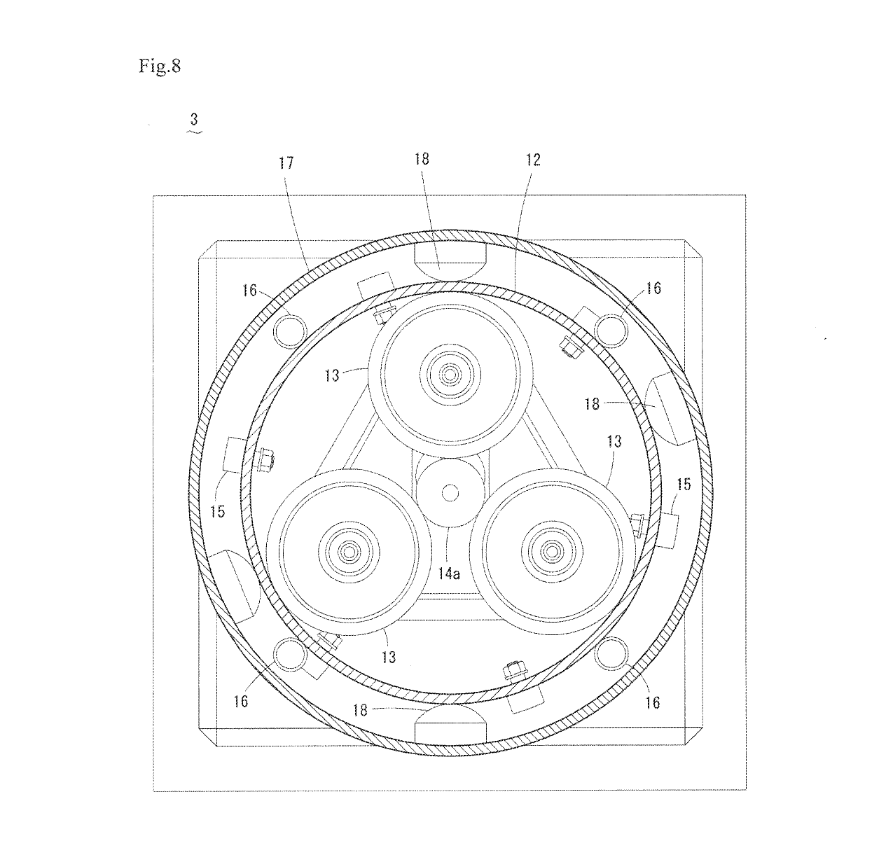

When the solar panel 1 is impacted by a strong wind, the wind force on the surface of the panel transmits a great force on the rotary drum 12, which may include a large bending moment. In order to reinforce the rotary drum 12, a reinforcement drum 17 may be concentrically fixed to the outer periphery of the rotary drum 12, and bearings 18 are interposed between both drums 12 and 17 as illustrated in FIG. 8. This configuration can prevent the rotary drum 12 from collapsing without hindering the horizontal rotation of the rotary drum 12.

An example (control example) of the operation of the solar power generation system will be discussed. The solar power generation system is firstly installed such that the horizontal or azimuthal direction in which the solar panel 1 is swung coincides with the east-west orientation, and waits until sunrise in an initial state in which the solar panel 1 is tilted at an angle of 45° to the left (to the east) by controlling the supporting portion 2. At sunrise, solar irradiation by which solar power generation is enabled is detected by an optical sensor or an illumination sensor, for example, and the supporting portion 2 is controlled on the basis of the detection signal. With this, the solar panel 1 is pivoted or rotated about a horizontal axis (which may be concentric with axle 9) in the direction toward the horizontal state shown in FIG. 3. Generally, the solar panel 1 is preferably brought into the horizontal state around noon at which the culmination altitude of the sun is the highest.

When the solar panel 1 is in the horizontal state, this condition is detected by sensors, such as a level gauge or a limit switch, timers such as an alarm watch that detects noon, or other units, to control the revolving portion 3. That is, when the solar panel 1 is in the horizontal state, the rotary drum 12 is horizontally rotated 180° to cause the solar panel 1 to be reversed left to right.

After such reverse operation is completed, the supporting portion 2 is continuously controlled to then rotate the electric motor 5 in the supporting portion 2 in the direction opposite to the direction so far (in the morning). With this, the solar panel 1 is pivoted until it is tilted to the west at an angle of 45°, which may be a mirror image of the orientation of the panel in FIG. 2.

According to the operation discussed above, the solar panel 1 can be rotated to the left and right within the range of 90° by tracking the movement of the sun in the daytime.

After the daytime operation described above is finished due to sunset or the like, the revolving portion 3 is controlled to cause the solar panel 1 to be again reversed left to right by rotating the supporting portion 2 180°, back to the orientation shown in FIG. 2. Thus, the solar panel 1 can be returned to its initial state.

As described above, in the solar power generation system according to the present embodiment, the tilt control angle of the solar panel 1 by the supporting portion 2 is 45° at only one side, but due to the reverse operation by the revolving portion 3, the solar panel 1 can be swung at both sides within the range of 90°. Therefore, the tilt control for the solar panel 1 includes the control for bringing the solar panel 1 into the horizontal state from the initial state at an angle of 45°, and the control for tilting the solar panel 1 at an angle of 45° from the horizontal state. Since the former control (operation control in the morning) requiring particularly large motor torque is performed only once, the power consumption of the electric motor 5 can be further reduced than conventional systems.

In the present invention, the electric motor 14 is also required in the revolving portion 3, and power is consumed in the revolving portion 3. However, only a power consumption amount smaller than that for pivoting the solar panel 1 is required. In addition, during the reverse operation around noon as discussed in the above operation example, the solar panel 1 is in the horizontal state, so that the wind resistance of the panel is small. Therefore, power consumption is further reduced.

It is obvious that the disclosed adjustable angle solar power generation system is not limited to the above embodiment. In the swing mechanism for the solar panel 1 in the supporting portion 2, the reciprocating movement of the actuator 11 may be implemented by a link mechanism or the like in place of the wire 7, or the actuator 11 may be eliminated and power of the electric motor 5 may be directly transmitted to the rotatable axis 9 using gears or the like.

Further, in the revolving portion 3, the power source for rotationally driving the rotary drum 12 may be configured such that the rollers 13 are disposed outside the rotary drum 12, or may be configured such that the rollers 13 are replaced by gears, the rotary drum 12 is also provided with gears meshing with the gears, and the rotary drum 12 is horizontally rotated by such a gear structure.

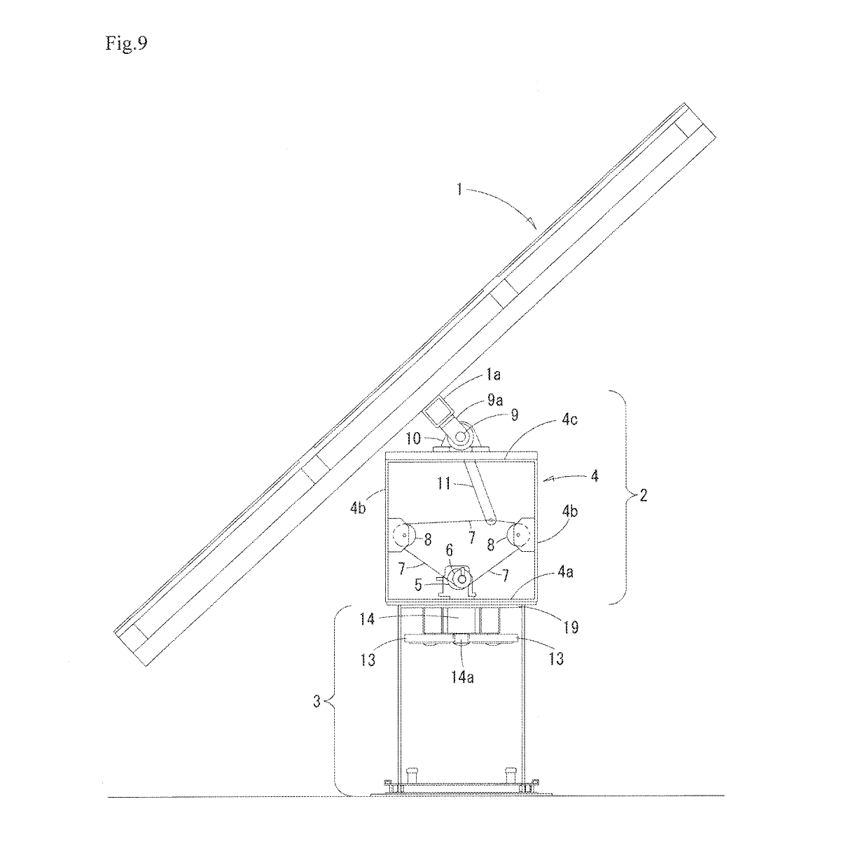

As illustrated in FIG. 9, the revolving portion 3 may be configured such that the rollers 13 and the electric motor 14, which are the power unit of the revolving portion 3, are provided on a horizontal plate 19 provided on the top surface of the rotary drum 12 in the inverted way of the above-mentioned embodiment. In this modification, the power unit of the revolving portion 3 is located at the upper part of the rotary drum 12 (FIG. 5), whereby the center of gravity of the entire device can be stabilized.

In addition, the drive control of the supporting portion 2 and the revolving portion 3 is arbitrary. In the above embodiment, the movement in one day has been discussed with the initial state being set as the state in which the solar panel 1 is tilted at an angle of 45°. However, the horizontal state may be defined as the initial state. In this case, when the sunlight (sunrise) is detected by the optical sensor or the like at the beginning of the day, the solar panel 1 is driven to be tilted at an angle of 45°, and then, is swung until it is brought into the horizontal state. Then, the solar panel 1 is reversed by the revolving portion 3 and is tilted at an angle of 45° at the opposite side, and when the optical sensor no longer detects the sunlight (in other words, when sunset is detected), the solar panel 1 is again returned to the horizontal state that is the initial state. If the horizontal state is defined as the initial state as described above, the resistance of wind exerted on the solar panel 1 is reduced, and the problem of damage by wind during a standby state at night in the initial state can be reduced.

In addition, the supporting portion 2 and the revolving portion 3 may be simultaneously driven, and in this case, the solar panel 1 can be three-dimensionally controlled. Thus, in autumn or winter in Japan or at a land at which the culmination altitude of the sun is low, the solar panel 1 can be effectively controlled to face the sunlight to enhance power generation efficiency.

What is claimed is:

1. A solar power generation system comprising:
a supporting portion that supports a solar panel so as to be capable of being tilted within a range in which the solar panel is tilted at an arbitrary angle in only one direction from a horizontal state; and
a revolving portion that supports the supporting portion from below such that the supporting portion is rotatable about a vertical axis.

2. The solar power generation system according to claim 1, wherein the revolving portion supports the supporting portion to be rotatable such that a tilt range of the solar panel is reversed with the vertical axis being defined as a symmetric axis, enabling the solar panel to tilt in both directions within the same range before and after the rotation of the revolving portion.

3. The solar power generation system according to claim 2, wherein the revolving portion is rotatable within a range of 180° in normal and reverse directions around the vertical axis.

4. The solar power generation system according to claim 1, wherein the revolving portion is rotationally driven when the solar panel is in the horizontal state.

5. The solar power generation system according to claim 1, wherein the supporting portion and the revolving portion are simultaneously driven.

6. The solar power generation system according to claim 1, wherein an arbitrary tilt angle of the solar panel is a maximum of 45°.

7. The solar power generation system according to claim 1, wherein the supporting portion further includes
a rotatable axis provided at a center of a back of the solar panel;
an actuator that integrally projects from the rotatable axis obliquely downward and performs a reciprocating movement in a swing direction of the solar panel; and
a power source for the supporting portion, the power source operating the actuator so as to be capable of performing the reciprocating movement, and
the actuator projects from the rotatable axis to form an acute angle with a panel surface which is swung downward when the solar panel is swung.

8. The solar power generation system according to claim 1, wherein
the revolving portion further includes:
a rotary drum that supports the supporting portion on a cylinder so as to be rotatable in a horizontal direction;
a roller that has an outer peripheral surface in contact with a cylinder wall of the rotary drum and is freely rotatable in the horizontal direction; and
a power source for the revolving portion, the power source applying power to the roller to rotationally drive the rotary drum.

9. The solar power generation system according to claim 8, wherein the rotary drum has a hollow cylindrical shape, and the roller is mounted inside the rotary drum.

10. The solar power generation system according to claim 8, wherein a reinforcement drum is concentrically disposed outside the rotary drum through a bearing.

11. A method of operating a solar power generation system, the method comprising:
supporting a solar panel by a supporting portion to be capable of being tilted within a range in which the solar panel is tilted at an arbitrary angle in only one direction from a horizontal state; and
supporting the supporting portion on a revolving portion from below such that the supporting portion is rotatable about a vertical axis.

12. The method of claim 11, further comprising tilting the solar panel to maintain a flat panel surface of the solar panel perpendicular to rays of solar radiation during daylight.

13. The method of claim 12, further comprising continuing to tilt the solar panel to maintain the flat panel surface perpendicular to the rays of solar radiation until the solar panel is horizontal; and then rotating the supporting portion by the revolving portion.

14. The method of claim 13, wherein rotating the supporting portion by the revolving portion includes rotating the supporting portion 180°.

15. The method of claim 13, further comprising, subsequent to rotating the supporting portion, continuing to tilt the solar panel by the supporting portion to maintain the flat panel surface perpendicular to the rays of solar radiation during daylight.

16. The method of claim 15, further comprising, subsequent to continuing to tilt the solar panel, tilting the solar panel back to a horizontal orientation and rotating the supporting portion and the solar panel 180°.

17. The method of claim 16, wherein tilting the solar panel back to horizontal orientation occurs after sunset to minimize wind resistance.
